(19) United States
(12) Patent Application Publication
(10) Pub. No.: US 2024/0100496 A1
(43) Pub. Date: Mar. 28, 2024

(54) RISERS AND METHODS FOR OPERATING RISERS

(71) Applicant: Dow Global Technologies LLC, Midland, MI (US)

(72) Inventors: Matthew T. Pretz, Lake Jackson, TX (US); Donald F. Shaw, Forked River, NJ (US); Richard Edwards Walter, Long Valley, NJ (US); Fermin Alejandro Sandoval, Pearland, TX (US); Albert Meza, Houston, TX (US)

(73) Assignee: Dow Global Technologies LLC, Midland, MI (US)

(21) Appl. No.: 18/267,534

(22) PCT Filed: Dec. 14, 2021
(86) PCT No.: PCT/US2021/063294

§ 371 Date: Jun. 15, 2023

Related U.S. Application Data
(60) Provisional application No. 63/126,106, filed on Dec. 16, 2020.

(51) Int. Cl. B01J 8/18; B01J 8/26

(52) U.S. Cl. CPC B01J 8/1863; B01J 8/26; B01J 2208/00017; B01J 2208/00991

(57) ABSTRACT

According to one or more embodiments of the present disclosure, a riser may be operated by a method including repeatedly heating and cooling a riser between an operational temperature and a non-operational temperature. When the riser is heated from a non-operational temperature to an operational temperature, the riser undergoes thermal expansion. When the riser is cooled from an operational temperature to a non-operational temperature, the riser undergoes thermal contraction. The riser undergoes irreversible growth over repeated heating and cooling cycles, and the length of a lower section of an upper riser portion is sized to accommodate the irreversible growth from cycled thermal expansion of the riser.

### CROSS-REFERENCE TO RELATED APPLICATIONS

This application claims the benefit of and priority to U.S. Application Ser. No. 63/126,106 filed on Dec. 16, 2020, and entitled “Risers and Methods for Operating Risers,” the entire contents of which are incorporated by reference in the present disclosure.

### TECHNICAL FIELD

Embodiments described herein generally relate to chemical processing systems and, more specifically, to risers.

### BACKGROUND

Many chemicals provide feedstocks for forming basic materials. For example, light olefins may be utilized as base materials to produce many types of goods and materials, where ethylene may be utilized to manufacture polyethylene, ethylene chloride, or ethylene oxides. Such products may be utilized in product packaging, construction, textiles, etc. Thus, there is an industry demand for light olefins, such as ethylene, propylene, and butene. Some chemicals, such as light olefins, may be produced by reaction processes that utilize riser reactors. Risers may be used in reaction, as well as the regeneration of catalysts utilized in the process.

### SUMMARY

In some embodiments, such as those described herein, risers may undergo cycled thermal expansion and contraction. It has been discovered that cycled thermal expansion and contraction may lead to irreversible growth of the riser. Generally, when the riser is at an operational temperature, the riser is in an expanded state. As gasses and particulate solids pass through the riser, coke may accumulate in crevices present in refractory material lining the interior of the riser. This accumulation may result in irreversible growth of the riser over multiple thermal cycles. As such, complications may arise in the design of chemical processing systems that utilize such risers. For example, designs in many embodiments should be able to account for both the thermal expansion and contraction of the riser as well as the irreversible growth of the riser.

Presently disclosed risers address these problems in some or all respects. The risers disclosed herein may include two distinct riser portions, which allow for both the thermal expansion and contraction of the riser as well as the irreversible growth of the riser. In one or more embodiments, a riser may comprise an upper riser portion and a lower riser portion, where the lower section of the upper riser portion is positioned around the upper section of the lower riser portion. In one or more embodiments, the upper riser portion and the lower riser portion are not in contract, and the lower end of the upper riser portion is sized to accommodate both thermal expansion and contraction of the riser as well as irreversible growth of the riser. For example, the lower section of the upper riser portion may have a length that accounts for the irreversible growth of both the upper riser portion and the lower riser portion. In one or more embodiments, a suitable length of the lower section of the upper riser portion may ensure that the gap between the upper riser portion and the lower riser portion remains open even when the riser is in a thermally expanded state and has undergone additional irreversible growth. Furthermore, a proper length of the lower section of the upper riser portion may ensure that any outlets in the upper riser portion are not blocked by the lower riser portion when the lower riser portion and upper riser portion undergo thermal expansion and irreversible growth.

According to one or more embodiments disclosed herein, a riser may be operated by a method comprising repeatedly heating and cooling a riser between an operational temperature and a non-operational temperature. The riser comprises a lower riser portion comprising an interior surface and an upper section comprising an upper end. The lower riser portion terminates at the upper end of the upper section of the lower riser portion. The riser further comprises an upper riser portion comprising an interior surface, an upper section, and a lower section. A diameter of the lower section of the upper riser portion is from 101% to 150% of a diameter of the upper section of the lower riser portion. The upper section of the lower riser portion and lower section of the upper riser portion vertically overlap one another such that the lower section of the upper riser portion is positioned around the upper section of the lower riser portion. The lower riser portion and upper riser portion are not in contact or connected to one another. When the riser is heated from a non-operational temperature to an operational temperature, the riser undergoes thermal expansion. When the riser is cooled from an operational temperature to a non-operational temperature, the riser undergoes thermal contraction. Irreversible growth of the riser may occur over multiple heating and cooling cycles, and a length of the lower section of the upper riser portion is sized to accommodate both the thermal expansion and the irreversible growth from cycled thermal expansion of the lower riser portion and the upper riser portion.

It is to be understood that both the foregoing brief summary and the following detailed description present embodiments of the technology, and are intended to provide an overview or framework for understanding the nature and character of the technology as it is claimed. The accompanying drawings are included to provide a further understanding of the technology, and are incorporated into and constitute a part of this specification. The drawings illustrate various embodiments and, together with the description, serve to explain the principles and operations of the technology. Additionally, the drawings and descriptions are meant to be merely illustrative, and are not intended to limit the scope of the claims in any manner.

Additional features and advantages of the technology disclosed herein will be set forth in the detailed description that follows, and in part will be readily apparent to those skilled in the art from that description or recognized by practicing the technology as described herein, including the detailed description that follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a reactor system, according to one or more embodiments disclosed herein;

FIG. 2 schematically depicts an elevation view of riser, according to one or more embodiments disclosed herein;

FIG. 3 schematically depicts an elevation view of another riser, according to one or more embodiments disclosed herein;

FIG. 4A schematically depicts an elevation view of a riser with a gap between the lower riser portion and the upper riser portion, according to one or more embodiments disclosed herein;

FIG. 4B schematically depicts an elevation view of a riser with an obstructed gap between the lower riser portion and the upper riser portion, according to one or more embodiments disclosed herein;

FIG. 5A schematically depicts an elevation view of a riser with an outlet according to one or more embodiments disclosed herein; and

FIG. 5B schematically depicts an elevation view of a riser with an obstructed outlet according to one or more embodiments disclosed herein.

It should be understood that the drawings are schematic in nature, and do not include some components of a fluid catalytic reactor system commonly employed in the art, such as, without limitation, temperature transmitters, pressure transmitters, flow meters, pumps, valves, and the like. It would be known that these components are within the spirit and scope of the present embodiments disclosed. However, operational components, such as those described in the present disclosure, may be added to the embodiments described in this disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

Described herein are one or more embodiments of risers and methods for operating risers. In some embodiments disclosed herein, the risers are disclosed for use in reactor sections of reactors systems that also include a regeneration section. Such embodiments may utilize a recycled solid catalyst in a fluidized bed. Specific example embodiments disclose the risers in use in dehydrogenation reaction systems designed to form light olefins, or alkyl aromatic olefins, such as styrene. However, it should be understood that the risers disclosed herein may be utilized in a wide variety of chemical processes and systems. As would be appreciated by one skilled in the art, the technology disclosed herein may find wide applicability to mechanical design of chemical processing systems that utilize risers.

As described herein, portions of system units such as reaction vessel walls, separation section walls, or riser walls, may comprise a metallic material, such as carbon steel, 304H stainless steel, 321 stainless steel, 374 stainless steel, Incoloy 800®, Incoloy 800H®, Incoloy 800HT®, Incoloy 617®, Inconel®, or chrome. In addition, the walls of various system units may have portions that are attached with other portions of the same system unit or to another system unit. Sometimes, the points of attachment or connection are referred to herein as “attachment points” and may incorporate any known bonding medium such as, without limitation, a weld, an adhesive, a solder, etc. It should be understood that components of the system may be “directly connected” at an attachment point, such as a weld. It should further be understood that two components that are “proximate” on another are in direct contact or immediately near one another such that a relatively small intermediate parts such as connectors or adhesive materials connects them.

Generally, “inlet ports” and “outlet ports” of any system unit described herein refer to openings, holes, channels, apertures, gaps, or other like mechanical features in the system unit. For example, inlet ports allow for the entrance of materials to the particular system unit and outlet ports allow for the exit of materials from the particular system unit. Generally, an outlet port or inlet port will define the area of a system unit to which a pipe, conduit, tube, hose, transport line, or like mechanical feature is attached, or to a portion of the system unit to which another system unit is directly attached. While inlet ports and outlet ports may sometimes be described herein functionally in operation, they may have similar or identical physical characteristics, and their respective functions in an operational system should not be construed as limiting on their physical structures. Other ports may comprise an opening in the given system unit where other system units are directly attached.

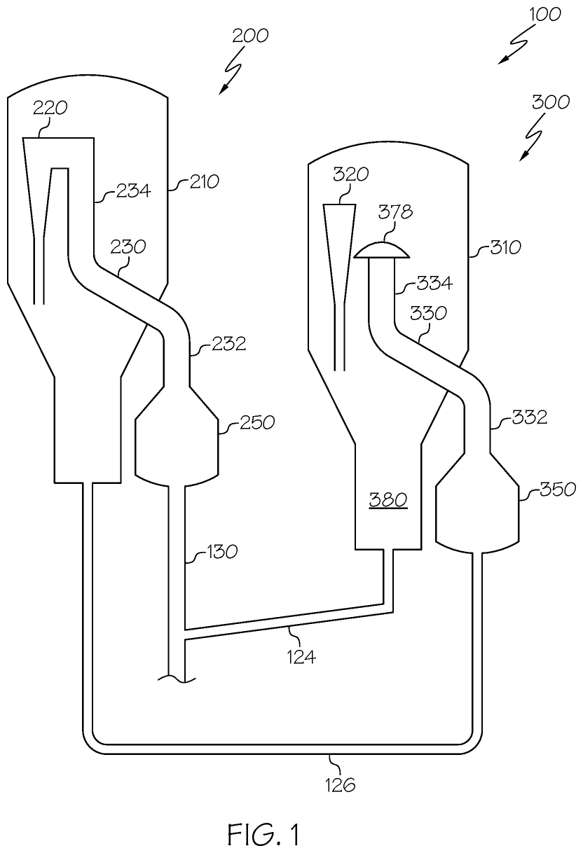

As described herein, a riser may be utilized within reactor systems for producing light olefins from hydrocarbon feed streams. The reactor systems and methods for producing light olefins will now be discussed in detail. Now referring to FIG. 1, an example reactor system 100 is schematically depicted. The reactor system 100 generally comprises multiple system units, such as a reactor section 200 and a regenerator section 300. As used herein in the context of FIG. 1, a reactor section 200 generally refers to the portion of a reactor system 100 in which the major process reaction takes place, and the particulate solids are separated from the olefin-containing product stream of the reaction. In one or more embodiments, the particulate solids may be spent, meaning that they are at least partially deactivated. Also, as used herein, a regenerator section 300 generally refers to the portion of a fluid catalytic reactor system where the particulate solids are regenerated, such as through combustion, and the regenerated particulate solids are separated from the other process material, such as evolved gasses from the combusted material previously on the spent particulate solids or from supplemental fuel. The reactor section 200 generally includes a reaction vessel 250, a riser 230 including an exterior riser segment 232 and an interior riser segment 234, and a particulate solid separation section 210. The regenerator section 300 generally includes a particulate solid treatment vessel 350, a riser 330 including an exterior riser segment 332 and an interior riser segment 334, and a particulate solid separation section 310. Generally, the particulate solid separation section 210 may be in fluid communication with the particulate solid treatment vessel 350, for example, by standpipe 126, and the particulate solid separation section 310 may be in fluid communication with the reaction vessel 250, for example, by standpipe 124 and transport riser 130.

Generally, the reactor system 100 may be operated by feeding a hydrocarbon feed and fluidized particulate solids into the reaction vessel 250, and reacting the hydrocarbon feed by contact with fluidized particulate solids to produce an olefin-containing product in the reaction vessel 250 of the reactor section 200. The olefin-containing product and the particulate solids may be passed out of the reaction vessel 250 and through the riser 230 to a gas/solids separation device 220 in the particulate solid separation section 210, where the particulate solids may be separated from the olefin-containing product. The particulate solids may then be transported out of the particulate solid separation section 210 to the particulate solid treatment vessel 350. In the particulate solid treatment vessel 350, the particulate solids may be regenerated by chemical processes. For example, the spent particulate solids may be regenerated by one or more of oxidizing the particulate solid by contact with an oxygen containing gas, combusting coke present on the particulate solids, and combusting a supplemental fuel to heat the particulate solid. The particulate solids may then be passed out of the particulate solid treatment vessel 350 and through the riser 330 to a riser termination device 378, where the gas and particulate solids from the riser 330 are partially separated. The gas and remaining particulate solids from the riser 330 are transported to gas/solids separation device 320 in the particulate solid separation section 310 where the remaining particulate solids are separated from the gasses from the regeneration reaction. The particulate solids, separated from the gasses, may be passed to a solid particulate collection area 380. The separated particulate solids are then passed from the solid particulate collection area 380 to the reaction vessel 250, where they are further utilized. Thus, the particulate solids may cycle between the reactor section 200 and the regenerator section 300.

It should be understood that risers and methods for operating risers disclosed herein are not limited to the reactor system 100 displayed in FIG. 1. For example, FIG. 1 depicts risers 230 and 330 comprising curved riser segments and diagonal riser segments. It should be appreciated that the risers described herein may comprise curved segments, may comprise diagonal segments, may comprise horizontal segments, and may comprise vertical segments. Additionally, risers contemplated herein may be free from curved segments, diagonal segments, and horizontal segments and may be substantially vertically oriented. Additionally, the risers depicted in FIG. 1 enter particulate solid separation sections 210 and 310 through a side walls of particulate solid separation sections 210 and 310. However, risers contemplated herein may additionally enter particulate solid separation sections 210 and 310 through the bottom of particulate solid separation sections 210 and 310 in embodiments in which the risers do not comprise curved segments. Furthermore, risers contemplated herein may be used in chemical processing systems distinct from those disclosed in FIG. 1.

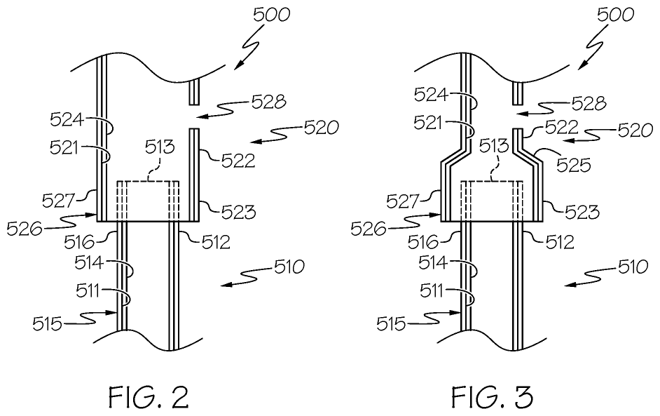

Now referring to FIGS. 2 and 3, embodiments of riser 500 are depicted. In one or more embodiments, the riser 500 may be present in reactor system 100 in either the reactor section 200 or the regenerator section 300. In one or more embodiments, it is contemplated that the riser 500 depicted in FIGS. 2 and 3 may be a portion of interior riser segment 234 or 334 as depicted in FIG. 1. Additionally, it should be understood that riser 500 may be utilized in any system in which such a riser would be suitable, not limited to reactor system 100. As such, the riser 500 is described in the context of reactor system 100, but is not limited to use in such a reactor system.

Generally, the riser 500 may act to transport reactants, products, and/or particulate solids from a reaction vessel 250 or particulate solid treatment vessel 350 of FIG. 1 to the gas/solids separation device 220 or 320 housed within particulate solid separation section 210 or 310 as depicted in FIG. 1. In one or more embodiments, the riser 500 may be generally cylindrical in shape (i.e., having a substantially circular cross sectional shape), or may alternately be non-cylindrically shaped, such as prism shaped with cross sectional shape of triangles, rectangles, pentagons, hexagons, octagons, ovals, or other polygons or curved closed shapes, or combinations thereof.

Referring to FIGS. 2 and 3, the riser 500 may comprise a lower riser portion 510 and an upper riser portion 520. The lower riser portion 510 may comprise a riser wall 515 comprising an interior surface 511 and an exterior surface 516. The interior surface 511 of the lower riser portion 510 may be lined with refractory material 514. As such, the refractory material 514 may be directly connected to the interior surface 511 of the riser wall 515. For example, the refractory material 514 may be attached to the interior surface 511 of the riser wall 515 with anchors such has hex mesh, steer anchors, or other such means to hold the refractory material 514 to the interior surface 511 of the riser wall 515. In one or more embodiments, at least a portion of the exterior surface 516 of the lower riser portion 510 may be lined with refractory material (not depicted). The lower riser portion 510 may comprise an upper section 512 comprising an upper end 513. The lower riser portion 510 may terminate at the upper end 513 of the upper section 512. In one or more embodiments, the upper section 512 of the lower riser portion 510 may have a substantially constant diameter. As described herein, when a diameter is “substantially constant,” the diameter does not vary by more than 5%, more than 3%, or even more than 1%.

The upper riser portion 520 may comprise a riser wall 526 comprising an interior surface 521 and an exterior surface 527. The interior surface 521 of the upper riser portion 520 may be lined with refractory material 524. As such, the refractory material 524 may be directly connected to the interior surface 521 of the riser wall 526. For example, the refractory material may be attached to the interior surface 521 of the riser wall 526 with anchors such as hex mesh, steer anchors, or other such means to hold the refractory material 524 to the interior surface 521 of the riser wall 526. In one or more embodiments, at least a portion of the exterior surface 527 of the upper riser portion 520 may be lined with refractory material (not depicted). The upper riser portion 520 may comprise an upper section 522 and a lower section 523. In one or more embodiments, the upper section 522 of the upper riser portion 520 may have a substantially constant diameter. In one or more embodiments, the upper section 522 of the upper riser portion 520 may comprise an outlet 528.

In one or more embodiments, the lower section 523 of the upper riser portion 520 may have a substantially constant diameter. The diameter of the lower section 523 of the upper riser portion 520 may be from 101% to 150% of the diameter of the upper section 512 of the lower riser portion 510. For example, the diameter of the lower section 523 of the upper riser portion 520 may be from 101% to 150%, from 101% to 140%, from 101% to 130%, from 101% to 120%, from 101% to 110%, from 110% to 150%, from 120% to 150%, from 130% to 150%, from 140% to 150%, or any combination or sub-combination of those ranges of the diameter of the upper section 512 of the lower riser portion 510. As such, the upper section 512 of the lower riser portion 510 and the lower section 523 of the upper riser portion 520 vertically overlap one another such that the lower section 523 of the upper riser portion 520 is positioned around the upper section 512 of the lower riser portion 510.

Referring now to FIG. 2, in one or more embodiments, the upper riser portion 520 may have a substantially constant diameter. As such, the diameter of the lower section 523 of the upper riser portion 520 and the diameter of the upper section 522 of the upper riser portion 520 may be substantially the same, such that the diameter of the lower section 523 of the upper riser portion 520 is within 5% of the diameter of the lower section 523 of the upper riser portion 520.

Referring now to FIG. 3, in one or more embodiments, the diameter of the lower section 523 of the upper riser portion 520 may be from 105% to 125% of the diameter of the upper section 522 of the upper riser portion 520. For example, the diameter of the lower section 523 of the upper riser portion 520 may be from 105% to 125%, from 105% to 120%, from 105% to 115%, from 105% to 110%, from 110% to 125%, from 115% to 125%, from 120% to 125%, or any combination or sub-combination of those ranges of the diameter of the upper section 522 of the upper riser portion 520. Additionally, in one or more embodiments, the diameter of the upper section 522 of the upper riser portion 520 may be substantially the same as the diameter of the upper section 512 of the lower riser portion 510, such that the diameter of the upper section 522 of the upper riser portion 520 is within 5% of the diameter of the upper section 512 of the lower riser portion 510. In one or more embodiments, the diameter of the upper section 522 of the upper riser portion 520 may be greater than or equal to 100% of the diameter of the upper section 512 of the lower riser portion 510.

Still referring to FIG. 3, the upper riser portion 520 may comprise a transition section 525 connecting the upper section 522 of the upper riser portion 520 to the lower section 523 of the upper riser portion 520. In one or more embodiments, the transition section 525 of the upper riser portion 520 may not have a constant diameter, and the diameter of the transition section 525 may change from the diameter of the lower section 523 of the upper riser portion 520 to the diameter of the upper section 522 of the upper riser portion 520 over a height of the transition section 525. As such, the transition section 525 may comprise a frustum geometry. In one or more embodiments, the transition section 525 may be positioned between the upper section 522 and the lower section 523 of the upper riser portion 520. Accordingly, in one or more embodiments, the transition section 525 may be directly connected to the upper section 522 of the upper riser portion 520, the lower section 523 of the upper riser portion 520, or both.

In one or more embodiments, the lower riser portion 510 and the upper riser portion 520 are not directly connected to one another. For example, the exterior surface 516 of the riser wall 515 of the lower riser portion 510 is not directly connected to the refractory material 524 lining the interior surface 521 of the riser wall 526 of the upper riser portion 520. Without wishing to be bound by theory, it is believed that when the lower riser portion and the upper riser portion are not connected to one another less stress may be placed on the riser during thermal expansion and contraction of the riser. For example, the upper riser portion 520 may be directly connected to additional system components above the upper riser portion 520 and may expand downwards. Likewise, the lower riser portion 510 may be directly connected to additional system components below the lower riser portion 510 and may expand upwards. If the upper riser portion 520 and the lower riser portion 510 were directly connected stress from the thermal expansion of the riser portions 520 and 510 in opposite directions may damage the riser 500.

In one or more embodiments, the lower section 523 of the upper riser portion 520 may be positioned concentrically around the upper section 512 of the lower riser portion 510. In one or more embodiments, the upper section 512 of the lower riser portion 510 may comprise guides that reduce eccentricity of the upper riser portion 520 and the lower riser portion 510. The guides may be directly connected to the outer surface 516 of the upper section 512 of the lower riser portion 510. Under normal operating conditions, the guides generally do not contact the lower section 523 of the upper riser portion 520; however, under some operating conditions, the guides may contact the lower section 523 of the upper riser portion 520. In one or more embodiments, the lower section 523 of the upper riser portion 520 may comprise guides that reduce the eccentricity of the upper riser portion 520 and the lower riser portion 510. The guides may be directly connected to the interior surface 521 of the riser wall 526 of the upper riser portion 520. Under normal operating conditions, the guides generally do not contact the exterior surface 516 of the riser wall 515 of the lower riser portion 510; however, under some operating conditions, the guides may contact the exterior surface 516 of the riser wall 515 of the lower riser portion 510. Alternatively, the guides may be directly connected to the refractory material 524 lining the interior surface 521 of the riser wall 526 of the upper riser portion 520. The guides may ensure that the upper riser portion 520 and the lower riser portion 510 are properly aligned as the upper riser portion 520 and lower riser portion 510 undergo thermal expansion and contraction. As such, the exterior surface 516 of the riser wall 515 of the lower riser portion may slide along the guides as the upper riser portion 520 and the lower riser portion 510 expand and contract. Examples of such guides are disclosed in Attorney Docket Number: DOW 83804 MA, the entirety of which is incorporated by reference herein.

In one or more embodiments, the riser wall 515 and 526 may comprise one or more metals or alloys. For example, the riser wall 515 and 526 may comprise one or more of carbon steel, stainless steel, nickel alloys, nickel-chromium alloys, and chromium. In one or more embodiments the riser wall 515 and 526 may comprise at least one of 304H stainless steel, 321 stainless steel, 374 stainless steel, Incoloy 800®, Incoloy 800H®, Incoloy 800HT®, Incoloy 617®, Inconel®, or chrome. Incoloy 800®, Incoloy 800H®, Incoloy 800HT®, Incoloy 617®, and Inconel® are registered trademarks of Special Metals Corporation. However, it is contemplated that other equivalent alloys may also be used in the risers disclosed herein. It is also to be understood that any suitable metal or alloy may be used in the riser wall 515 and 526.

As described herein, “refractory material” refers to materials that are chemically and physically stable at high temperatures, such as temperatures above 500° C. In one or more embodiments, the refractory material may comprise high density erosion type materials such as ActChem 85, R-Max MP, Rescocast AA22S, or other high density erosion resistant type refractories. In one or more embodiments, the refractory material may further comprise a hex mesh anchor system. As described herein, a “hex mesh” is a mesh structure comprising hexagonal or substantially hexagonal openings. It is also contemplated that mesh structures comprising openings of various other shapes including triangles, squares, pentagons, octagons, etc. may be used in conjunction with the high density erosion resistant type materials in the refractory material. In one or more embodiments, the high density erosion type materials may be present within the mesh structure of the hex mesh to comprise the refractory material 514 and 524. Generally, the refractory materials 514 and 526 may be porous, and coke and/or particulate solids may enter the pores in the refractory materials 514 and 526 and accumulate over multiple thermal cycles. Additionally, small cracks may develop in the refractory material 514 and 526 at operational temperature, due to riser expansion. In one or more embodiments, cracks may form in the high density erosion resistant type material or between the high density erosion resistant type material and the hex mesh. As such, coke and/or particulate solids may accumulate in the cracks in the refractory material 514 and 526 during operation of the riser 500.

Generally, the riser 500 may act to transport reactants, products, and/or particulate solids from a reaction vessel 250 or particulate solid treatment vessel 350 of FIG. 1 to the gas/solids separation device 220 or 320 housed within particulate solid separation section 210 or 310. In one or more embodiments, the riser 500 may be heated from a non-operational temperature to an operational temperature by passing a mixture comprising reactants, products, and/or particulate solids through the riser 500. In alternative embodiments, the riser 500 may be heated from a non-operational temperature to an operational temperature by passing a mixture comprising an inert gas, such as nitrogen, and/or particulate solids through the riser 500.

The riser 500 may be repeatedly heated and cooled. In one or more embodiments, the riser 500 may be heated from a non-operational temperature to an operational temperature and subsequently cooled from an operational temperature to a non-operational temperature. Generally, the riser 500 may be at a non-operational temperature when the riser 500 is not in use. In one or more embodiments, the non-operational temperature may be an ambient temperature. The riser may be at an operational temperature when the riser is in use, for example, when reactor system 100 is operating. In one or more embodiments, the operational temperature of the riser 500 may be from 500° C. to 950° C. For example, the operational temperature of the riser may be from 500° C. to 950° C., from 550° C. to 950° C., from 600° C. to 950° C., from 650° C. to 950° C., from 700° C. to 950° C., from 750° C. to 950° C., from 800° C. to 950° C., from 850° C. to 950° C., from 900° C. to 950° C., from 500° C. to 900° C., from 500° C. to 850° C., from 500° C. to 800° C., from 500° C. to 750° C., from 500° C. to 700° C., from 500° C. to 650° C., from 500° C. to 600° C., from 500° C. to 550° C. or any combination or sub-combination of these ranges.

In one or more embodiments, when the riser 500 is heated from a non-operational temperature to an operational temperature, the riser 500 may undergo thermal expansion. Such thermal expansion may result in elongation, or growth, of the riser. For example, when the upper section 522 of the upper riser portion 520 is fixed, the upper riser portion may grow downward toward the lower riser portion 510. Likewise, lower riser portion 510 may grow upward toward the upper riser portion 520. Furthermore, when the riser 500 is cooled from an operational temperature to a non-operational temperature, the riser 500 may undergo thermal contraction. As such, the upper riser portion may contract away from the lower riser portion 510 and the lower riser portion 510 may contract away from the upper riser portion 520.

In one or more embodiments, when the riser 500 is at an operational temperature, coke and/or particulate solids may accumulate in the refractory material 514 of the lower riser portion 510 and the refractory material 524 of the upper riser portion 520. The coke and/or particulate solids accumulated in the refractory material may result in irreversible growth of the riser 500 over repeated heating and cooling cycles. Without wishing to be bound by theory, when the riser 500 is at an operational temperature and has undergone thermal expansion, crevices and/or pores in the refractory material may also expand. As reactants, products, and particulate solids pass through the riser 500, coke, or even particulate solids, may accumulate in the crevices and/or pores in the refractory material. When the riser 500 is cooled from an operational temperature to a non-operational temperature, the riser 500, including the refractory material and the crevices and/or pores therein, undergoes thermal contraction. Over multiple heating and cooling cycles, enough coke and/or particulate solids may accumulate in the crevices and/or pores of the refractory lining to cause the riser 500 to grow, or elongate, irreversibly.

For example, when riser 500 is new, there is no coke and/or particulate solids accumulated within the refractory material 514 and 524, and the upper riser portion 520 and the lower riser portion 510 each have an original length. When the riser 500 is brought to an operational temperature by gas and particulate solids passing through the riser 500, the upper riser portion 520 and the lower riser portion 510 may each undergo thermal expansion to a first expanded length and coke and/or particulate solid may accumulate in the refractory material 514 and 524. When the riser 500 is cooled, the coke accumulated in the refractory material 514 and 524 may prevent the upper riser portion 520 and the lower riser portion 510 from fully contracting and returning to the original length. This may result in deformation of the riser wall 515 and 526. As such, when the riser 500 is subsequently heated to an operational temperature, the upper riser portion 520 and the lower riser portion 510 will undergo thermal expansion past the first expanded length. As this cycle continues, the upper riser portion 520 and the lower riser portion 510 may continue to elongate as additional coke becomes accumulated in the refractory material.

In one or more embodiments, the riser 500 may undergo irreversible growth from cycled thermal expansion at a rate from 0.03 inches to 0.35 inches per 10 feet of riser per cycle. For example, the riser 500 may undergo irreversible growth from cycled thermal expansion at a rate from 0.03 in. to 0.35 in., from 0.05 in. to 0.35 in., from 0.10 in. to 0.35 in., from 0.15 in. to 0.35 in., from 0.20 in. to 0.35 in., from 0.25 in. to 0.35 in., from 0.30 in. to 0.35 in., from 0.03 in. to 0.30 in., from 0.03 in. to 0.25 in., from 0.03 in. to 0.20 in., from 0.03 in. to 0.15 in., from 0.03 in. to 0.10 in., or even from 0.03 in. to 0.05 in. per 10 feet of riser per cycle. In one or more embodiments, the riser 500 may undergo irreversible thermal growth from cycled thermal expansion at a rate from 0.5 in. to 5.0 in. per 10 feet of riser over the lifespan of the riser. For example, the riser may undergo irreversible thermal growth from cycled thermal expansion at a rate from 0.5 in. to 5.0 in., from 0.5 in. to 4.5 in., from 0.5 in. to 4.0 in., from 0.5 in. to 3.5 in., from 0.5 in. to 3.0 in., from 0.5 in. to 2.5 in., from 0.5 in. to 2.0 in., from 0.5 in. to 1.5 in., from 0.5 in. to 1.0 in., from 1.0 in. to 5.0 in., from 1.5 in. to 5.0 in., from 2.0 in. to 5.0 in., from 2.5 in. to 5.0 in., from 3.0 in. to 5.0 in., from 3.5 in. to 5.0 in., from 4.0 in. to 5.0 in., or even from 4.5 in. to 5.0 in. per 10 ft. of riser over the lifespan of the riser. As described herein, the lifespan of the riser may refer to a number of cycles from 5 to 100. In one or more embodiments, the lifespan of the riser may be from 20 to 100 lifetime cycles, from 5 to 50 lifetime cycles, or from 20 to 50 lifetime cycles.

In one or more embodiments, the riser 500 is designed with the presently described irreversible growth taken into consideration. As it is understood that risers may undergo not only reversible thermal expansion via change in temperature, but also irreversible growth over multiple cycles from, e.g., coke and/or particulate solids accumulating in the refractory material. When this is taken into consideration, the space between the upper riser portion 520 and lower riser portion 510 is generally designed to be greater than without this taken irreversible growth into consideration. That is, without accounting for irreversible growth, one skilled in the art may design insufficient spacing between the lower riser portion 510 and upper riser portion 520, causing mechanical issues that are costly to mitigate or correct following continued operation of the riser (i.e., thermal cycling from normal operation). On the other hand, taking account for the irreversible growth described herein, a designer may provide additional spacing between the upper riser portion 520 and lower riser portion 510. As is described herein, the embodiment of FIGS. 2 and 3 may be designed in view of the irreversible expansion.

As such, in one or more embodiments, a length of the lower section 523 of the upper riser portion 520 is sized to accommodate the irreversible growth from cycled thermal expansion of the lower riser portion 510 and the upper riser portion 520. The lower section 523 of the upper riser portion 520 may accommodate both thermal expansion and irreversible growth from cycled thermal expansion by providing a distance between the upper end 513 of the upper section 512 of the lower riser portion 510 and the upper section 523 of the upper riser portion 520. In one or more embodiments, the lower section 523 of the upper riser portion 520 may accommodate both thermal expansion and irreversible growth from cycled thermal expansion by providing a distance between the upper end 513 of the upper section 512 of the lower riser portion 510 and the transition section 525 of the upper riser portion 520. For example, the distance may be greater than an expected thermal expansion and irreversible growth from cycled thermal expansion of the upper riser portion 520 and the lower riser portion 510 over the lifespan of the riser.

In one or more embodiments, the lower section 523 of the upper riser portion 520 may be sized to ensure that the upper section 512 of the lower riser portion 510 does not come into contact with the transition section 525 of the upper riser portion 520 during normal operations. In one or more embodiments, the lower section 523 of the upper riser portion 520 may be sized such that the upper section 512 of the lower riser portion 510 does not overlap with the upper section 522 of the upper riser portion 520 and as such does not block any outlet in the upper section 522 of the upper riser portion 520. In one or more embodiments, the lower section 523 of the upper riser portion 520 may be sized such that a gap sufficient to allow gas to enter the riser 500 remains open between the lower riser portion 510 and the upper riser portion 520 even when the riser 500 has undergone irreversible growth.

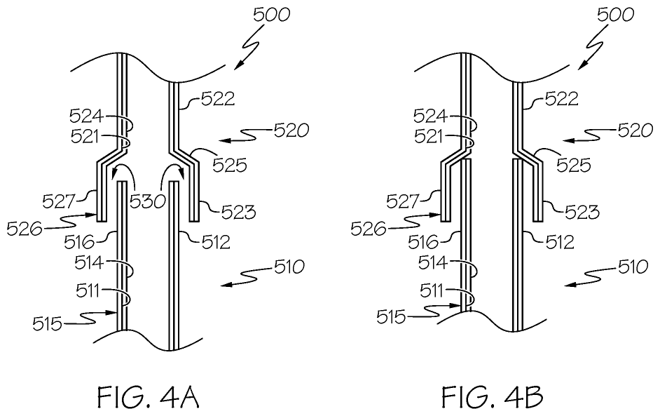

Without wishing to be bound by theory, it is believed that if the irreversible growth from cycled thermal expansion of the riser 500 is not accounted for during the design of the riser 500, then the irreversible growth in addition to thermal expansion of the riser 500 may prevent the riser 500 from properly functioning when it is at an operational temperature. For example, if irreversible growth is not accounted for the gap 530 between the upper riser portion 520 and the lower riser portion 510 may close, preventing gas from passing into the riser 500, as depicted in FIGS. 4A and 4B. FIG. 4A depicts a riser 500 in which the gap 530 between the upper riser portion 520 and the lower riser portion 510 is present even when the riser 530 is at an operational temperature and even when the riser 500 has undergone irreversible growth. FIG. 4B depicts a riser 500 that has undergone irreversible growth and where the gap 530 between the upper riser portion 520 and the lower riser portion 510 is no longer present when the riser 500 is at an operational temperature.

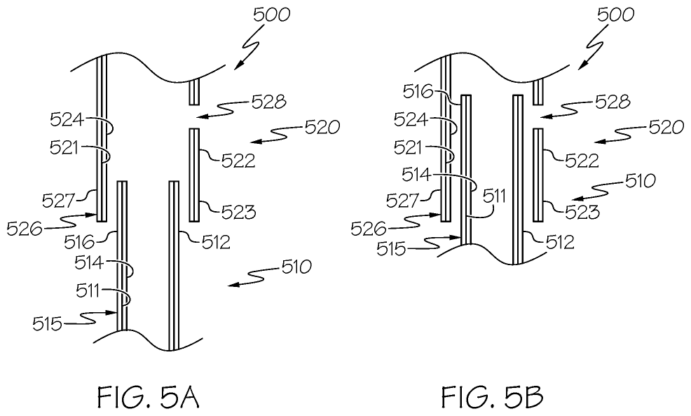

Additionally, the lower riser portion 510 and upper riser portion 520 may overlap so much that an outlet in the upper riser portion 520 is partially or completely blocked by the lower riser portion 510, as depicted in FIGS. 5A and 5B. FIG. 5A depicts a riser 500 in which the outlet 528 in the upper riser portion 520 is not obstructed by the lower riser portion 510 even when the riser 500 is at an operational temperature and has undergone irreversible growth. On the other hand, FIG. 5B depicts a riser 500 where the outlet 528 in the upper riser portion 520 is completely obstructed by the lower riser portion 510 when the riser 500 is at an operational temperature and has undergone irreversible growth.

As described hereinabove, risers may be used in dehydrogenation reactors, for example, the dehydrogenation reactor system 100 depicted in FIG. 1. In such embodiments, the riser 500 may be suitable for operation under the process conditions described hereinbelow.

In one or more embodiments, based on the shape, size, and other processing conditions such as temperature and pressure in the reaction vessel 250 and the riser 230, the reaction vessel 250 may operate in a manner that is or approaches isothermal, such as in a fast fluidized, turbulent, or bubbling bed reactor, while the riser 230 may operate in more of a plug flow manner, such as in a dilute phase riser reactor. For example, the reaction vessel 250 may operate as a fast fluidized, turbulent, or bubbling bed reactor and the riser 230 may operate as a dilute phase riser reactor, with the result that the average catalyst and gas flow moves concurrently upward. As the term is used herein, “average flow” refers to the net flow, i.e., the total upward flow minus the retrograde or reverse flow, as is typical of the behavior of fluidized particles in general. As described herein, a “fast fluidized” reactor may refer to a reactor utilizing a fluidization regime wherein the superficial velocity of the gas phase is greater than the choking velocity and may be semi-dense in operation. As described herein, a “turbulent” reactor may refer to a fluidization regime where the superficial velocity of less than the choking velocity and is more dense than the fast fluidized regime. As described herein, a “bubbling bed” reactor may refer to a fluidization regime wherein well-defined bubbles in a highly dense bed are present in two distinct phases. The “choking velocity” refers to the minimum velocity required to maintain solids in the dilute-phase mode in a vertical conveying line. As described herein, a “dilute phase riser” may refer to a riser reactor operating at transport velocity, where the gas and catalyst have about the same velocity in a dilute phase.

In one or more embodiments, the pressure in the reaction vessel 250 may range from 6.0 to 100 pounds per square inch absolute (psia, from about 41.4 kilopascals, kPa, to about 689.4 kPa), but in some embodiments, a narrower selected range, such as from 15.0 psia to 35.0 psia, (from about 103.4 kPa to about 241.3 kPa), may be employed. For example, the pressure may be from 15.0 psia to 30.0 psia (from about 103.4 kPa to about 206.8 kPa), from 17.0 psia to 28.0 psia (from about 117.2 kPa to about 193.1 kPa), or from 19.0 psia to 25.0 psia (from about 131.0 kPa to about 172.4 kPa). Unit conversions from standard (non-SI) to metric (SI) expressions herein include “about” to indicate rounding that may be present in the metric (SI) expressions as a result of conversions.

In additional embodiments, the weight hourly space velocity (WHSV) for the disclosed process may range from 0.1 pound (lb) to 100 lb of chemical feed per hour (h) per lb of catalyst in the reactor (lb feed/h/lb catalyst). For example, where a reactor comprises a reaction vessel 250 that operates as a fast fluidized, turbulent, or bubbling bed reactor and a riser 230 that operates as a riser reactor, the superficial gas velocity may range therein from 2 feet per second (ft/s, about 0.61 meters per second, m/s) to 80 ft/s (about 24.38 m/s), such as from 2 ft/s (about 0.61 m/s) to 10 ft/s (about 3.05 m/s), in the reaction vessel 250, and from 30 ft/s (about 9.14 m/s) to 70 ft/s (about 21.31 m/s) in the riser 230. In additional embodiments, a reactor configuration that is fully of a riser type may operate at a single high superficial gas velocity, for example, in some embodiments at least 30 ft/s (about 9.15 m/s) throughout.

In additional embodiments, the ratio of catalyst to feed stream in the reaction vessel 250 and riser 230 may range from 5 to 100 on a weight to weight (w/w) basis. In some embodiments, the ratio may range from 10 to 40, such as from 12 to 36, or from 12 to 24.

In additional embodiments, the catalyst flux may be from 1 pound per square foot-second (lb/ft²-s) (about 4.89 kg/m²-s) to 30 lb/ft²-s (to about 146.5 kg/m2-s) in the reaction vessel 250, and from 10 lb/ft²-s (about 48.9 kg/m2-s) to 250 lb/ft²-s (about 1221 kg/m2-s) in the riser 230.

### EXAMPLES

The following examples illustrate features of the present disclosure but are not intended to limit the scope of the disclosure. The following examples discuss the irreversible growth of riser portions according to one or more embodiments disclosed herein.

### Example 1: Measurement of Irreversible Riser Growth

The height of a riser used in a pilot scale operation was measured. The riser was vertically oriented and straight. In other words, the riser did not contain any non-vertical segments. The measurements were compared to the measurements in the original as-built drawings of the riser. The riser was installed, and a first set of measurements was taken after 3 months of plant run time, during which the riser underwent five thermal cycles. A second set of measurements was taken after 3 months of run time, during which the riser underwent two thermal cycles, and a third set of measurements was taken after an additional 3 months of run time, during which the riser underwent one thermal cycle. The total growth of the riser is summarized in Table 1.

TABLE 1

| Operating | Total Riser | Riser | Differential | | Growth |
|---|---|---|---|---|---|
| Time | Length | Growth | Growth | # | per cycle |
| (Months) | (in.) | (in.) | (inches) | Cycles | (in/cycle) |
| 0 | 838 9/16 | 0 | 0 | 0 | |
| 3 | 842¾ | 4 3/16 | 4 3/16 | 5 | 0.8375 |
| 6 | 844 7/16 | 5⅞ | 1 11/16 | 2 | 0.8438 |
| 9 | 845⅛ | 6 9/16 | 11/16 | 1 | 0.6875 |

As shown in Table 1, the riser underwent irreversible growth of approximately 0.94 in. per 10 ft. of riser over 9 months. During that time, the riser underwent 8 thermal cycles. As such, the riser grew at a rate of approximately 0.12 in. per 10 feet of riser per thermal cycle.

### Example 2: Design of a Riser to Account for Irreversible Growth

A riser was designed to account for both thermal expansion and irreversible growth due to cycled thermal expansion. The riser 500 has a total length of 925 in. when the riser is at a non-operational temperature. The lower section 523 of the upper riser portion 520 overlaps with the upper section 512 of the lower riser portion 510 about 4 in., when the riser is at a non-operational temperature. When the riser is brought to an operational temperature, the riser undergoes thermal expansion of about 12 in., when normal thermal expansion at 700° C. is assumed to be 1.556 in of growth per 10 ft. of riser. As such, to accommodate thermal expansion of the riser 500 and the overlap between the lower riser portion 510 and the upper riser portion 520, the length of the lower section 523 of the upper riser portion 520 is at least 16 in. Furthermore, the length of the lower section 523 of the upper riser portion 520 includes additional length of about 2 in. to allow space for gas to enter the riser 500 through a gap between the upper riser portion 520 and the lower riser portion 510. As such, the lower section 523 of the upper riser portion 520 has a length of about 18 in. to account for overlap of the upper riser portion 520 and the lower riser portion 510, thermal expansion of the riser 500, and a gap between the lower riser portion 510 and the upper riser portion 520.

To account for irreversible thermal growth of the riser 500, one should account not only for overlap of the upper riser portion 520 and the lower riser portion 510, thermal expansion of the riser 500, and a gap between the lower riser portion 510 and the upper riser portion 520, as discussed above, but also for the amount that the riser 500 will irreversibly grow over the lifetime of the riser 500. When the rate of irreversible thermal growth is assumed to be 0.1 in. per 10 feet of riser per cycle and the riser 500 is expected to undergo 50 cycles during its lifetime, the irreversible thermal growth of the riser 500 is expected to be about 39 in. over the lifetime of the riser 500. As such, to accommodate irreversible thermal growth of the riser 500, thermal expansion of the riser 500, overlap of the upper riser portion 520 and the lower riser portion 510, and a gap between the lower riser portion 510 and the upper riser portion 520, the length of the lower section 523 of the upper riser portion 520 is at least 57 in. It should be understood that the risers described in the present disclosure are not limited to the dimensions disclosed in this example and that that this example merely illustrates the process of designing a riser to accommodate not only thermal expansion but also irreversible growth due to cycled thermal expansion.

In a first aspect of the present disclosure, a riser may be operated by a method comprising repeatedly heating and cooling a riser between an operational temperature and a non-operational temperature. The riser comprises a lower riser portion comprising an interior surface and an upper section comprising an upper end. The lower riser portion terminates at the upper end of the upper section of the lower riser portion. The riser further comprises an upper riser portion comprising an interior surface, an upper section, and a lower section. A diameter of the lower section of the upper riser portion is from 101% to 150% of a diameter of the upper section of the lower riser portion. The upper section of the lower riser portion and lower section of the upper riser portion vertically overlap one another such that the lower section of the upper riser portion is positioned around the upper section of the lower riser portion. The lower riser portion and upper riser portion are not in contact or connected to one another. When the riser is heated from a non-operational temperature to an operational temperature, the riser undergoes thermal expansion. When the riser is cooled from an operational temperature to a non-operational temperature, the riser undergoes thermal contraction. Irreversible growth of the riser may occur over multiple heating and cooling cycles, and a length of the lower section of the upper riser portion is sized to accommodate both the thermal expansion and the irreversible growth from cycled thermal expansion of the lower riser portion and the upper riser portion.

A second aspect of the present disclosure may include the first aspect where coke or particulate solids or both accumulates in the refractory material of the lower riser portion and the upper riser portion while the riser is at an operational temperature, and the coke or particulate solids or both accumulated in the refractory material results in irreversible growth of the riser over repeated heating and cooling cycles.

A third aspect of the present disclosure may include either of the first or second aspects where the diameter of the lower section of the upper riser portion is from 105% to 125% of the diameter of the upper section of the upper riser portion, and wherein the upper riser portion comprises a transition section connecting the upper section of the upper riser portion to the lower section of the upper riser portion.

A fourth aspect of the present disclosure may include the third aspect where a distance is provided between the upper end of the upper section of the lower riser portion and the transition section of the upper riser portion, and wherein the distance is greater than an expected thermal expansion and irreversible growth from cycled thermal expansion of the upper riser portion and the lower riser portion over the lifespan of the riser.

A fifth aspect of the present disclosure may include either of the third or fourth aspects where the transition section comprises a frustum geometry.

A sixth aspect of the present disclosure may include any of the first through third aspects where the upper riser portion has a substantially constant diameter.

A seventh aspect of the present disclosure may include the sixth aspect where the upper section of the upper riser portion further comprises an outlet and wherein the upper section of the lower riser portion does not block the outlet while the riser is at an operational temperature.

An eighth aspect of the present disclosure may include any of the first through seventh aspects where the riser undergoes irreversible growth from cycled thermal expansion at a rate from 0.5 inches to 5.0 inches per 10 feet of riser over the lifespan of the riser.

A ninth aspect of the present disclosure may include any of the first through eighth aspects where the riser undergoes irreversible growth from cycled thermal expansion at a rate from 0.03 to 0.35 inches per 10 feet of riser per cycle.

A tenth aspect of the present disclosure may include any of the first through ninth aspects where the riser is heated from the non-operational temperature to the operational temperature by passing a mixture comprising an inert gas and particulate solids through the riser.

An eleventh aspect of the present disclosure may include any of the first through tenth aspects where the operational temperature of the riser is from 500° C. to 950° C.

A twelfth aspect of the present disclosure may include any of the first through eleventh aspects where the non-operational temperature of the riser is ambient temperature.

A thirteenth aspect of the present disclosure may include any of the first through twelfth aspects where the riser wall of the lower riser portion and the riser wall of the upper riser portion comprise one or more of carbon steel, stainless steel, nickel alloys, nickel-chromium alloys, and chromium.

A fourteenth aspect of the present disclosure may include any of the first through thirteenth aspects where the riser comprises a substantially circular cross sectional shape.

In a fifteenth aspect of the present disclosure, a riser may be operated by a method comprising repeatedly heating and cooling a riser between an operational temperature and a non-operational temperature. The riser comprises a lower riser portion comprising an interior surface and an upper section comprising an upper end. The interior surface of the lower riser portion is lined with a refractory material. The lower riser portion terminates at the upper end of the upper section of the lower riser portion. The riser further comprises an upper riser portion comprising an interior surface, an upper section, and a lower section. The interior surface of the upper riser portion is lined with a refractory material. A diameter of the lower section of the upper riser portion is from 101% to 150% of a diameter of the upper section of the lower riser portion. The upper section of the lower riser portion and lower section of the upper riser portion vertically overlap one another such that the lower section of the upper riser portion is positioned around the upper section of the lower riser portion. The lower riser portion and upper riser portion are not in contact or connected to one another. When the riser is heated from a non-operational temperature to an operational temperature, the riser undergoes thermal expansion. Coke or particulate solids or both accumulates in the refractory material of the lower riser portion and the upper riser portion while the riser is at an operational temperature. When the riser is cooled from an operational temperature to a non-operational temperature, the riser undergoes thermal contraction. The coke or particulate solids or both accumulated in the refractory material results in irreversible growth of the riser over repeated heating and cooling cycles. A length of the lower section of the upper riser portion is sized to accommodate both the thermal expansion and the irreversible growth from cycled thermal expansion of the lower riser portion and the upper riser portion.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in some embodiments, the first component “consists” or “consists essentially of” that second component. It should further be understood that where a first component is described as “comprising” a second component, it is contemplated that, in some embodiments, the first component comprises at least 10%, at least 20%, at least 30%, at least 40%, at least 50%, at least 60%, at least 70%, at least 80%, at least 90%, at least 95%, or even at least 99% that second component (where % can be weight % or molar %). Additionally, the term “consisting essentially of” is used in this disclosure to refer to quantitative values that do not materially affect the basic and novel characteristic(s) of the disclosure.

It should be understood that any two quantitative values assigned to a property may constitute a range of that property, and all combinations of ranges formed from all stated quantitative values of a given property are contemplated in this disclosure.

1. A method for operating a riser, the method comprising:
repeatedly heating and cooling a riser between an operational temperature and a non-operational temperature, wherein the riser comprises:
a lower riser portion comprising a riser wall comprising an interior surface and an upper section comprising an upper end, wherein the lower riser portion terminates at the upper end of the upper section of the lower riser portion; and
an upper riser portion comprising a riser wall comprising an interior surface, an upper section, and a lower section, wherein a diameter of the lower section of the upper riser portion is from 101% to 150% of a diameter of the upper section of the lower riser portion, and the upper section of the lower riser portion and lower section of the upper riser portion vertically overlap one another such that the lower section of the upper riser portion is positioned around the upper section of the lower riser portion, and
wherein the lower riser portion and upper riser portion are not directly connected to one another;
wherein:
when the riser is heated from a non-operational temperature to an operational temperature, the riser undergoes thermal expansion;
when the riser is cooled from an operational temperature to a non-operational temperature, the riser undergoes thermal contraction;
irreversible growth of the riser occurs over repeated heating and cooling cycles; and
a length of the lower section of the upper riser portion is sized to accommodate both the thermal expansion and the irreversible growth from cycled thermal expansion from repeated heating and cooling cycles of the lower riser portion and the upper riser portion.

2. The method of claim 1, wherein:
coke or particulate solids or both accumulates in the refractory material of the lower riser portion and the upper riser portion while the riser is at an operational temperature; and
the coke or particulate solids or both accumulated in the refractory material results in irreversible growth of the riser over repeated heating and cooling cycles.

3. The method of claim 1, wherein:
the diameter of the lower section of the upper riser portion is from 105% to 125% of the diameter of the upper section of the upper riser portion; and
wherein the upper riser portion comprises a transition section connecting the upper section of the upper riser portion to the lower section of the upper riser portion.

4. The method of claim 3, wherein a distance is provided between the upper end of the upper section of the lower riser portion and the transition section of the upper riser portion, and wherein the distance is greater than an expected thermal expansion and irreversible growth from cycled thermal expansion of the upper riser portion and the lower riser portion over the lifespan of the riser.

5. The method of claim 3, wherein the transition section comprises a frustum geometry.

6. The method of claim 1, wherein the upper riser portion has a substantially constant diameter.

7. The method of claim 6, wherein the upper section of the upper riser portion further comprises an outlet and wherein the upper section of the lower riser portion does not block the outlet while the riser is at an operational temperature.

8. The method of claim 1, wherein the riser undergoes irreversible growth from cycled thermal expansion at a rate from 0.5 inches to 5.0 inches per 10 feet of riser over the lifespan of the riser.

9. The method of claim 1, wherein the riser undergoes irreversible growth from cycled thermal expansion at a rate from 0.03 to 0.35 inches per 10 feet of riser per cycle.

10. The method of claim 1, wherein the riser is heated from the non-operational temperature to the operational temperature by passing a mixture comprising an inert gas and particulate solids through the riser.

11. The method of claim 1, wherein the operational temperature of the riser is from 500° C. to 950° C.

12. The method of claim 1, wherein the non-operational temperature of the riser is ambient temperature.

13. The method of claim 1, wherein the riser wall of the lower riser portion and the riser wall of the upper riser portion comprise one or more of carbon steel, stainless steel, nickel alloys, nickel-chromium alloys, and chromium.

14. The method of claim 1, wherein the riser comprises a substantially circular cross sectional shape.

15. A method for operating a riser, the method comprising:
repeatedly heating and cooling a riser between an operational temperature and a non-operational temperature, wherein the riser comprises:
a lower riser portion comprising a riser wall comprising an interior surface and an upper section comprising an upper end, wherein the interior surface of the lower riser portion is lined with a refractory material, and wherein the lower riser portion terminates at the upper end of the upper section of the lower riser portion; and
an upper riser portion comprising a riser wall comprising an interior surface, an upper section, and a lower section, wherein the interior surface of the upper riser portion is lined with a refractory material, wherein a diameter of the lower section of the upper riser
